(19) United States
(12) Patent Application Publication
(10) Pub. No.: US 2018/0077875 A1
(43) Pub. Date: Mar. 22, 2018

(54) APPARATUS AND METHODS FOR PHENOTYPING PLANTS

(71) Applicant: Kent Allan Vander Velden, Johnston, IA (US)

(72) Inventor: Kent Allan Vander Velden, Johnston, IA (US)

(21) Appl. No.: 15/708,112

(22) Filed: Sep. 18, 2017

Related U.S. Application Data
(60) Provisional application No. 62/396,105, filed on Sep. 17, 2016.

(51) Int. Cl. A01G 7/00; H04N 5/247; H04N 5/225; G06T 7/90; A01G 1/00

(52) U.S. Cl. CPC A01G 7/00; H04N 5/247; H04N 5/2252; H04N 5/2253; G06K 7/10762; A01G 1/001; G06T 2207/10024; G06T 2207/30188; G06T 7/90

(57) ABSTRACT

An apparatus and methods for imaging and phenotyping of plants. Plants are placed in an enclosure having an access door and a floor. A turntable is disposed on the floor of the enclosure. A side view camera assembly attached to a frame of the apparatus is configured to capture images of a plant placed on the turntable. An overhead view camera assembly attached to the frame above the turntable is configured to capture images of a plant placed on the turntable.

### CROSS-REFERENCE TO RELATED APPLICATIONS

This application claims priority to U.S. Provisional Patent Application No. 62/396,105, filed on Sep. 17, 2016, the entirety of which is hereby incorporated herein by reference.

### FIELD OF THE INVENTION

This invention relates generally to plant phenotyping. In particular, this invention provides for a system and methods for capturing images of plants and obtaining phenotypic information from the images for the purpose of measuring agronomic performance of plants.

### BACKGROUND

Researchers who study plants seek to improve the throughput and consistency of their measurements by photographing the plants that form the basis of their experiments, and obtaining information about the plants' phenotype and other information regarding the health of the plant from captured images. Because a researcher may be responsible a large number of plants, or multiple experiments with each experiment involving a large number of plants, keeping track of the identity of each plant, the experimental conditions under which it was grown, images associated with each plant, and measurements associated with each plant becomes a challenging task. The difficulty of keeping track of plant data is multiplied when the imaging and measurements are repeated for the same plant over a period of time.

In addition to the data tracking difficulties, consistency can be an issue. Ambient lighting conditions can be highly variable, affecting color temperatures in captured images, and consequently affecting any measurements based on color that are obtained from the captured images. In addition, inconsistent positioning of the plant or camera could create inaccuracies in measurements obtained from captured images.

Attempts have been made to provide consistency and automated data handling for plant imaging and phenotyping; however, the plant imaging cabinets currently available suffer from many shortcomings. For example, current plant imaging and phenotyping systems provide images and analysis regarding each plant only after post-processing has occurred. However, if there is a problem with the system or plant during the imaging process, it may not be discovered for some time. By the time an issue has been discovered, the plant has continued to grow or may have been destroyed, making it impossible to recreate the missing image and measurements. Thus, an imaging and phenotyping system that immediately provides raw images and analysis to the user as they are captured is desirable to allow any system or plant issues to be corrected. Further, existing plant imaging and phenotyping systems rely upon fixed cameras or sensors that cannot be customized by the end user. If the end user wishes to use the system to capture other measurements besides color RGB images, for example, the user wishes to obtain hyperspectral, near infrared (NIR), or thermographic information about the plant, the user must use a completely separate system. Moving plants between multiple instruments creates inconsistencies in environment and plant positioning, preventing analysis of pixel-based correlation between instruments. Each instrument or camera has different dimensions of data, measuring different properties with different resolutions, and ideally, each instrument would report all its data for the same position on the plant so analyses of similarities can be performed. Thus, an imaging and phenotyping system having customizable instruments is desirable to allow a researcher to customize the system for their purposes and to ensure that the same plant features are being compared when multiple instruments are used.

### BRIEF SUMMARY

In accordance with one embodiment of the invention, an apparatus for capturing images and measurements of plants is provided. The apparatus comprises a generally rectangular enclosure having an access door that is configured to support subsystems of the apparatus and provide desirable and consistent lighting conditions within the enclosure. A generally horizontal floor of the enclosure supports a turntable configured to support and rotate plants for presentation to one or more cameras or other sensors. A side view camera system configured to capture images of the sides of plants is mounted adjacent to the turntable. An overhead view camera system configured to capture images of the tops of plants is disposed above the turntable. In some embodiments, one or more corner view camera systems may capture additional views of a plant situated on the turntable to enable 3D reconstruction and seeing features that may not otherwise be visible. In one embodiment, the side view, overhead view, and corner view systems may comprise an RGB camera, a hyperspectral imager, a near infrared or thermal imager, another instrument, or any combination of these. A lighting system disposed within the enclosure provides proper lighting conditions to enable use of the cameras of the side view, overhead view, and corner view systems. A computer disposed within or near the apparatus controls the function of the various other components of the apparatus, communicates with a separate server that stores plant images and other information about plants and experiments. A monitor affixed to the outer surface of the enclosure provides information about the operation of the apparatus and plants being imaged by the apparatus. In one embodiment, the monitor may be equipped with a touchscreen to allow users to interact with the apparatus. In other embodiments, separate input devices such as a keyboard, mouse, barcode reader, or RFID scanner may be provided to allow users to interact with the apparatus.

### BRIEF DESCRIPTION OF THE DRAWINGS

Having thus described the invention in general terms, reference will now be made to the accompanying drawings, which are not necessarily drawn to scale, and wherein:

FIG. 1 illustrates a front external view of an apparatus for imaging and phenotyping plants in accordance with an embodiment of the invention.

FIG. 2 illustrates a front view of the internal structure of an apparatus for imaging and phenotyping plants in accordance with an embodiment of the invention.

FIG. 3 illustrates an overhead view camera subassembly in accordance with an embodiment of the invention.

FIG. 4 illustrates a lighting subassembly in accordance with an embodiment of the invention.

FIG. 5 illustrates a side view camera subassembly in accordance with an embodiment of the invention.

FIG. 6 illustrates a lighting subassembly and a side view camera subassembly in accordance with an embodiment of the invention.

FIG. 7 illustrates a lighting subassembly and an alternative side-view camera subassembly in accordance with an embodiment of the invention.

FIG. 8 illustrates an alternative side-view camera subassembly in accordance with an embodiment of the invention.

FIG. 9 illustrates an alternative side-view camera subassembly in accordance with an embodiment of the invention.

FIG. 10 illustrates a corner view camera subassembly in accordance with an embodiment of the invention.

FIG. 11 illustrates a line scanning camera, such as a hyperspectral camera with incandescent lighting in accordance with an embodiment of the invention.

FIG. 12 illustrates a stationary frame based camera, such as an RGB, NIR, or thermographic camera, with incandescent, LED, or fluorescent lighting in accordance with an embodiment of the invention.

FIG. 13 illustrates a stationary frame based camera, such as an RGB, NIR, or thermographic camera, with fluorescent lighting in accordance with an embodiment of the invention.

FIG. 14 illustrates a stationary frame based camera, such as an RGB, NIR, or thermographic camera, with incandescent, LED, or fluorescent lighting in accordance with an embodiment of the invention.

FIG. 15 illustrates a method for capturing an image of a plant in accordance with an embodiment of the invention.

FIG. 16 illustrates a method of obtaining a side view image of a plant in accordance with an embodiment of the invention.

FIG. 17 illustrates a method of obtaining an overhead view image of a plant in accordance with an embodiment of the invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Some components of the apparatus are not shown in one or more of the figures for clarity and to facilitate explanation of embodiments of the present invention.

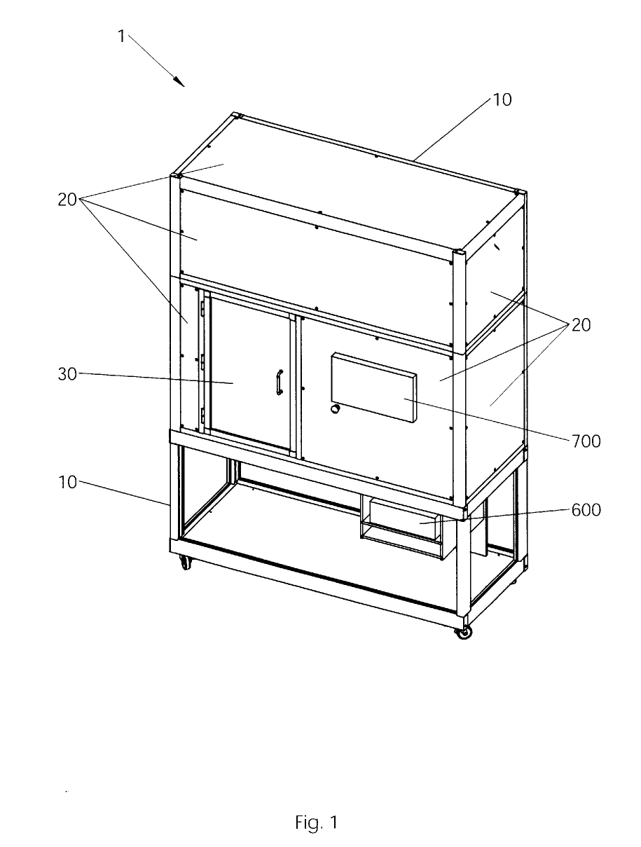

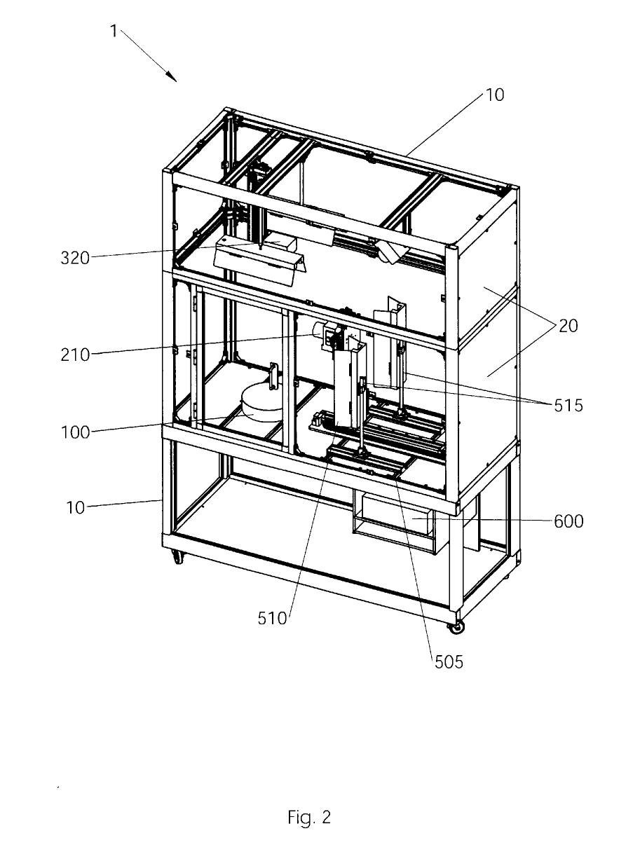

In accordance with one embodiment, FIG. 1 and FIG. 2 illustrate an apparatus 1 for capturing images of plants and other measurements. Apparatus 1 comprises a frame 10, panels 20 attached to frame 10, and an access door 30 attached to frame 10. A turntable 100, side view camera subassembly 200, overhead view camera subassembly 300, lighting subassembly 500, computer 600, and monitor 700 are attached to frame 10 or one or more panels 20.

### Frame 10

As shown in FIG. 1 and FIG. 2, frame 10 defines a generally box-shaped structure capable of providing stable mounting points for other components of the apparatus 1. Frame 10 may comprise rails defining the corners of the box-shaped structure having a top, a floor, and four sides. Frame 10 may further comprise one or more cross braces that span from one side to another side of the generally box-shaped structure and provide support for mounting various subassemblies of apparatus 1. For example, one or more cross braces may extend from one edge of the floor of frame 10 to the opposite and parallel edge of frame 10 to support side view camera subassembly 200. One or more additional cross braces may extend from one edge near the top of frame 10 to the opposite and parallel edge of frame 10 to support overhead view camera subassembly 300. Frame 10 may be constructed from metal, wood, plastic, or other rigid material capable of attaching to and supporting other structures and sub-systems of the apparatus 1.

The frame 10 may be constructed in two or more separable parts to enable the apparatus 1 to be transported more easily. For example, the frame 10 may comprise a base section, center section, and top section that can be separated from each other to allow for movement through a standard doorway.

### Panels 20

As shown in FIG. 1, panels 20 attach to the frame 10 to completely surround the internal components of apparatus 1 and to prevent access to the internal components and control electronics of the apparatus 1 during operation of the apparatus 1. Panels 20 act to create consistent lighting conditions within the apparatus 1, and also block drafts that might otherwise affect the plant during imaging. In one embodiment, panels 20 comprise metal-clad plastic composite panels. In other embodiments, panels 20 comprise panels made from plastic, metal, wood, or another material capable of enclosing the internal components of the apparatus 1. In one embodiment, panels 20 may be white to reduce lighting hots spots, reduce shadows, and to create more uniform lighting conditions. Panels 20 may be flat, or may be curved to eliminate lighting hot spots or visible vertical bars that appear lighter or darker.

### Access Door 30

As shown in FIG. 1, an access door 30 provides access to the internal components of the apparatus 1. When access door 30 is open, a user may place one or more plants inside apparatus 1 for photographing. Access door 30 may be closed to block ambient light surrounding apparatus 1 for uniform lighting conditions inside apparatus 1. Closing access door 30 also blocks access to the internal components of apparatus 1 during operation for user safety. An electronic sensor mounted on or near access door 30 and in communication with the computer 600 or motor controllers controlling motors 225, 240, 315, and 415 is configured to sense if access door 30 is open or closed. If the electronic sensor indicates that access door 30 is in the open position, computer 600 may prevent images from being captured, and may also prevent movable parts of apparatus 1 from moving until access door 30 has been closed. If computer 600 prevents operation of apparatus 1 due to an access door 30 open condition, a message informing the user to close the door may be displayed on the monitor 700.

### Turntable 100

As shown in FIG. 2, turntable 100 is configured to rotate a plant placed inside apparatus 1 to allow multiple views of a plant to be imaged. Rotation of a plant within apparatus 1 is desirable for multiple reasons. First, in a situation where a plant is imaged repeatedly over a period of time, it may be desirable to capture images of the same side of the plant each time it is imaged. For example, it may be desirable to capture images of the widest side of a plant to examine growth of the plant over time. Second, rotation is desirable to capture images of multiple sides of the plant. For example, a researcher may want to capture an image of the widest side of the plant and another image of the plant rotated 90 degrees, or multiple images that form a three dimensional reconstruction of the plant. Third, rotation is desirable to reduce the number of axes of motion in cases where an instrument will make physical contact with a plant. In these cases, the point of contact on the plant can be rotated toward the instrument, and the instrument in turn can be moved in a single axis of motion to come in contact with the correct contact point on the plant.

Turntable 100 may comprise a rotatable platform driven by a motor that is in communication with the computer 600. Turntable 100 may be mounted on the floor of the apparatus 1. Markings of various shapes may be drawn on the platform of turntable 100 to allow for consistent plant placement. For example, concentric circles may be drawn on the platform of turntable 100 to allow for consistent placement of plants in round pots, or rectangular or square markings may be present to allow for consistent placement of plants in rectangular or square pots.

### Side View Camera Subassembly 200

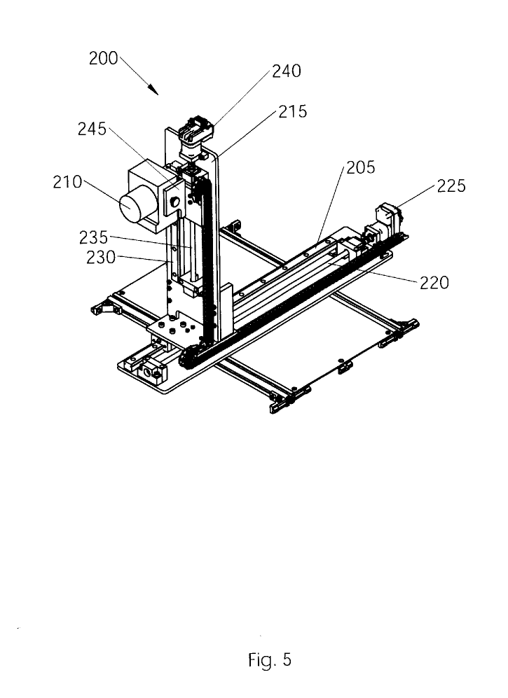

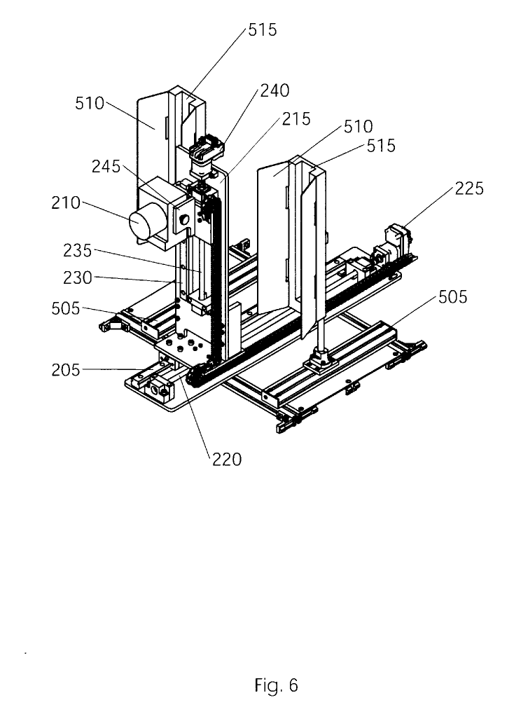

As shown in FIG. 5 and FIG. 6, in one embodiment, side view camera subassembly 200 is securely mounted on or near the floor of frame 10. The side view camera subassembly 200 allows images of the side of the plant to be captured, which enables measurement of the width and height of the plant as well as measurement of other properties of the plant, including morphology, color, as well as others. Side view camera subassembly 200 comprises a horizontal rail 205 and a horizontal lead screw 220 mounted to frame 10. Horizontal lead screw 220 is situated adjacent to and generally parallel to horizontal rail 205. One end of horizontal lead screw 220 engages the shaft of a motor 225 that is controlled by computer 600. Horizontal rail 205, horizontal lead screw 220, and motor 225 provide horizontal motion for side view camera subassembly 200.

Side view camera subassembly 200 further comprises a camera platform 215 that provides support for components that provide vertical movement for side view camera subassembly 200. Camera platform 215 comprises a first end that engages horizontal rail 205 and horizontal lead screw 220. Camera platform 215 is movable along the length of horizontal rail 205 and horizontal lead screw 220. Rotation of the shaft of motor 225 in a first direction causes camera platform 215 to move horizontally along the length of horizontal rail 205 and horizontal lead screw 220 toward the plant. Rotation of the shaft of motor 225 in a second direction that is opposite from the first direction causes camera platform 215 to move horizontally along the length of horizontal rail 205 and horizontal lead screw 220 away from the plant.

Mounted to camera platform 215 is a vertical rail 230 and a vertical lead screw 235. Vertical lead screw 235 is situated adjacent to and generally parallel to vertical rail 230. One end of vertical lead screw 235 engages a motor 240 that is controlled by computer 600. Vertical rail 230, vertical lead screw 235, and motor 240 provide for vertical motion for side view camera subassembly 200. A camera mount 245 provides a stable base for mounting side view camera 210. Camera mount 245 comprises a first surface that engages vertical rail 230 and vertical lead screw 235, and a second surface upon which side view camera 210 is securely connected. Camera mount 245 is movable along the lengths of vertical rail 230 and vertical lead screw 235. Rotation of the shaft of motor 240 in a first direction causes camera mount 245 to move vertically along the lengths of vertical rail 230 and vertical lead screw 235 toward horizontal rail 205 and horizontal lead screw 220. Rotation of the shaft of motor 240 in a second direction that is opposite from the first direction causes camera mount 245 to move vertically along the lengths of vertical rail 230 and vertical lead screw 235 away from horizontal rail 205 and horizontal lead screw 220.

Side view camera 210 may be a digital RGB camera, and may comprise an industrial camera or a consumer camera. While the above description of side view camera subassembly 200 anticipates that a digital RGB camera, other instruments may be substituted for side view camera 210. For example, a hyperspectral, near infrared or thermal imagers may be substituted for side view camera 210. The interchangeable nature of instruments in the apparatus 1 allows for all measurements to be performed in one enclosure, which prevents inconsistencies that would be caused by moving the plant or placement in a different environment for imaging. Because the same view can be captured using multiple instruments without moving the plant, a researcher can be sure that the same feature is examined across multiple instruments.

A vibration sensor, such as an accelerometer, may be connected to side view camera 210 to detect vibration after movement of side view camera 210 to ensure motion does not impact the clarity of image. Motion can come from intended motion of the camera and also vibrations from the environment. Measurement from the vibration sensor can be used to delay imaging and to correct for motion through image analysis methods.

Each camera subassembly can be made more independent by co-locating a computer to control the motors and camera, abstracting the implementation. The interface with the main computer is thus abstracted and the replacement and upgrading of camera systems simplified.

### Angle Mounted Camera Subassembly 400

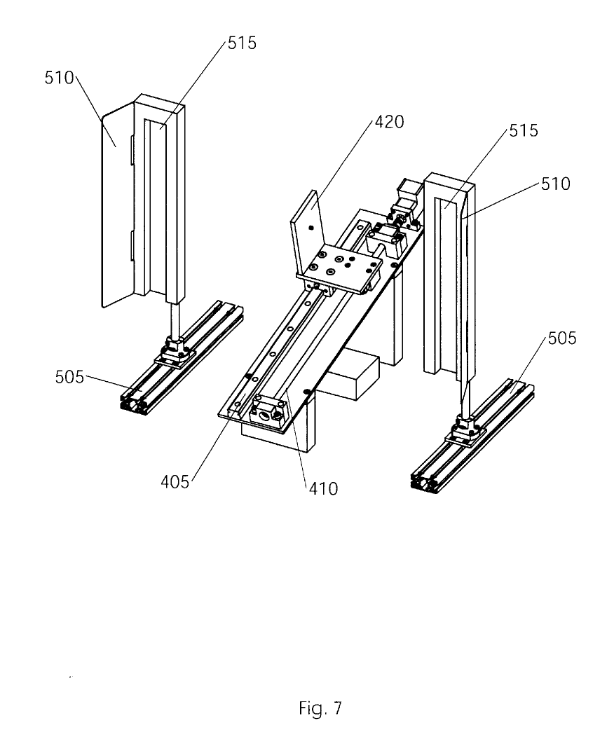

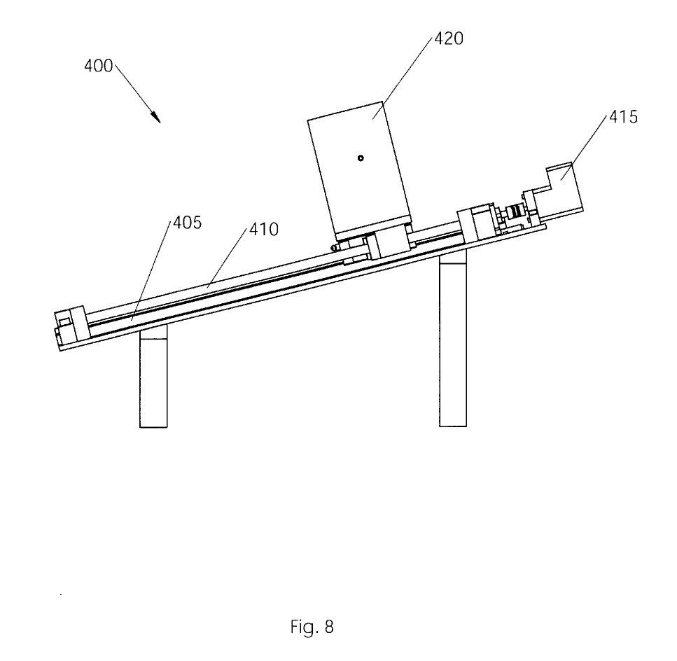

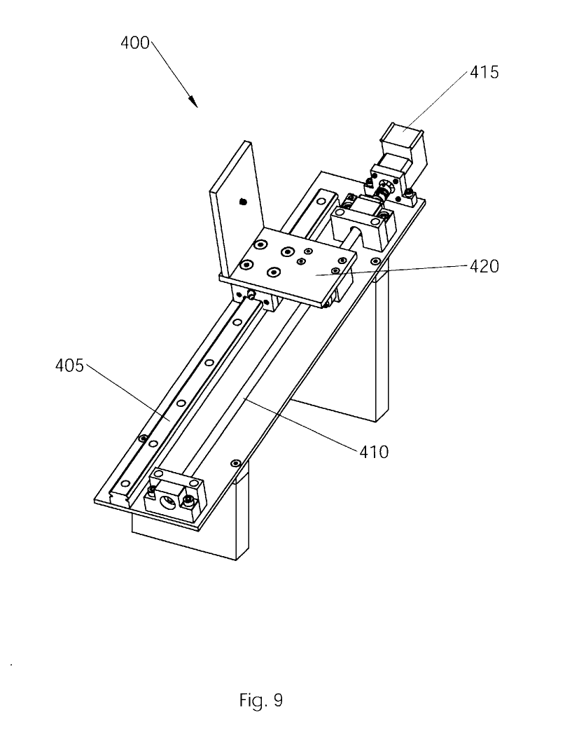

As shown in FIG. 7, FIG. 8, and FIG. 9, in an alternative embodiment, the side view camera subassembly 200 is replaced by an angle mounted camera subassembly 400. Because during normal plant grow there is a relationship between the needed horizontal and vertical positions of the camera to capture the plant, which can be estimated with a few simple measurements and approximated with a straight line, the side-view camera stage can be simplified to a single axis of motion which fits the expected horizontal and vertical positions of the camera with two axes. This reduces complexity and costs nearly in half because there is no duplication of parts. There is no loss of utility because most of the positions that a two axis design is able to go will never be visited in normal operation. A single angled axis system is all that's needed. In any of the motorized camera systems, a mechanism is used to determine a known reference point to measure from. This may be done by a proximity switch, an electromechanical switch, an absolute encoder, a glass scale, or other sort of precision measurement devices.

As in embodiments using the side view camera subassembly 200, the angle mounted camera subassembly 400 allows images of the side of the plant to be captured, which enables measurement of the width of the plant as well as measurement of other properties of the plant. However, the angle mounted camera subassembly 400 components are mounted at an angle, providing both horizontal and vertical camera movement while moving the camera in a single axis. By reducing motion to a single axis, fewer components are needed, the design is simpler, and cost is reduced.

Angle mounted camera subassembly 400 comprises a rail 405 and a lead screw 410. Rail 405 and lead screw 410 are securely mounted at an angle between zero and 90 degrees to frame 10. For example, rail 405 and lead screw 410 may be mounted to frame 10 at a 45 degree angle. Lead screw 410 is situated adjacent to and generally parallel to rail 405. One end of lead screw 410 engages a motor 415 that is controlled by computer 600. Rail 405, lead screw 410, and motor 415 provide for both horizontal and vertical motion for angle mounted camera subassembly 400. A camera mount 420 provides a stable base for mounting a camera 425. Camera mount 420 comprises a first surface that engages rail 405 and lead screw 410, and a second surface upon which camera 425 is securely connected. Camera mount 420 is movable along the lengths of rail 405 and lead screw 410. Rotation of the shaft of motor 415 in a first direction causes camera mount 420 to move along the lengths of rail 405 and lead screw 410 down and toward the plant. Rotation of the shaft of motor 415 in a second direction that is opposite from the first direction causes camera mount 420 to move along the lengths of rail 405 and lead screw 410 upward and away from the plant.

A vibration sensor, such as an accelerometer, may be connected to camera 425 to detect vibration after movement of camera 425.

### Corner View Camera Subassembly 450

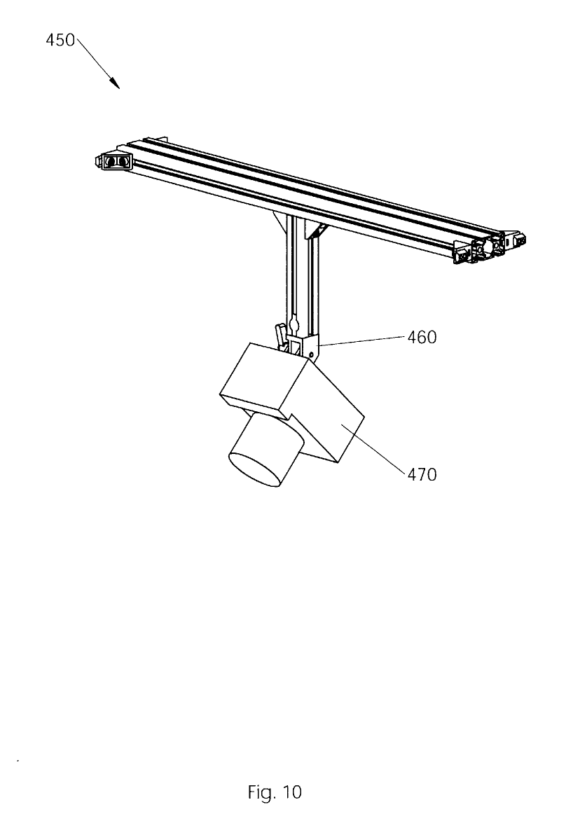

As shown in FIG. 10, a corner view camera subassembly 450 is securely mounted to frame 10 on or near an intersection of the top of frame 10 and one of the sides of apparatus 1. In some embodiments, corner view camera subassembly 450 may be implemented in addition to either side view camera subassembly 200 or angle view camera subassembly 400, and overhead view camera assembly 300. In other embodiments, corner view camera subassembly 450 is implemented instead of side view camera subassembly 200, angle view camera subassembly 400, or overhead view camera subassembly 300. When corner view camera subassembly 450 is the only camera subassembly used on apparatus 1, the complexity, weight, and cost of apparatus 1 are reduced. Use of corner view camera subassembly 450 allows plant images to be captured from an angled view that combines information available from side and overhead views. Anecdotal evidence indicates that images captured using a corner view camera subassembly 450 contain minimal obstructions, and maximum correlation between biomass and measured image area may be achievable.

Corner view camera subassembly 450 comprises a corner camera support 460 that provides a stable base for mounting corner view camera 470. In one embodiment, corner camera support 460 comprises a stationary structure that supports corner view camera 470 in a fixed position near an upper corner of apparatus 1. When corner view camera 470 is stationary, the complexity, weight, and cost of apparatus 1 are reduced, and vibration that may occur with a movable camera is eliminated. In other embodiments, corner view camera subassembly 450 comprises a structure similar to angle mounted camera subassembly 400 that is mounted near an upper corner of apparatus 1, allowing corner view camera 470 to move toward or away from the plant to be imaged.

### Overhead View Camera Subassembly 300

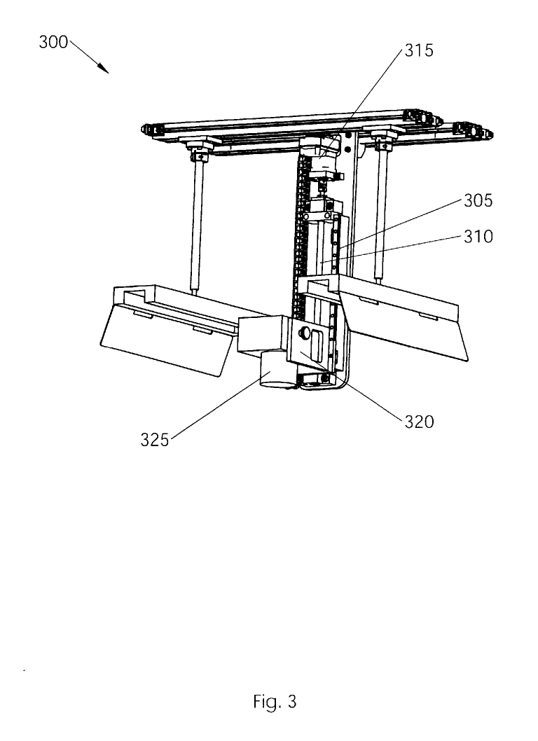

As shown in FIG. 3, an overhead view camera subassembly 300 is securely mounted to frame 10 on or near the top of frame 10. The overhead view camera subassembly 300 allows images of the top of the plant to be captured, which enables measurement of the width of the plant as well as measurement of other properties of the plant. Overhead view camera subassembly 300 comprises a vertical rail 305 and a vertical lead screw 310. Vertical lead screw 310 is situated adjacent to and generally parallel to vertical rail 305. One end of vertical lead screw 310 engages a motor 315 that is controlled by computer 600. Vertical rail 305, vertical lead screw 310, and motor 315 provide for vertical motion for overhead view camera subassembly 300. A camera mount 320 provides a stable base for mounting overhead view camera 325. Camera mount 320 comprises a first surface that engages vertical rail 305 and vertical lead screw 310, and a second surface upon which overhead view camera 325 is securely connected. Camera mount 320 is movable along the lengths of vertical rail 305 and vertical lead screw 310. Rotation of the shaft of motor 315 in a first direction causes camera mount 320 to move vertically along the lengths of vertical rail 305 and vertical lead screw 310 toward the plant. Rotation of the shaft of motor 315 in a second direction that is opposite from the first direction causes camera mount 320 to move vertically along the lengths of vertical rail 305 and vertical lead screw 310 away from the plant.

A vibration sensor, such as an accelerometer, may be connected to overhead view camera 325 to detect vibration after movement of overhead view camera 325.

### Lighting Subassembly 500

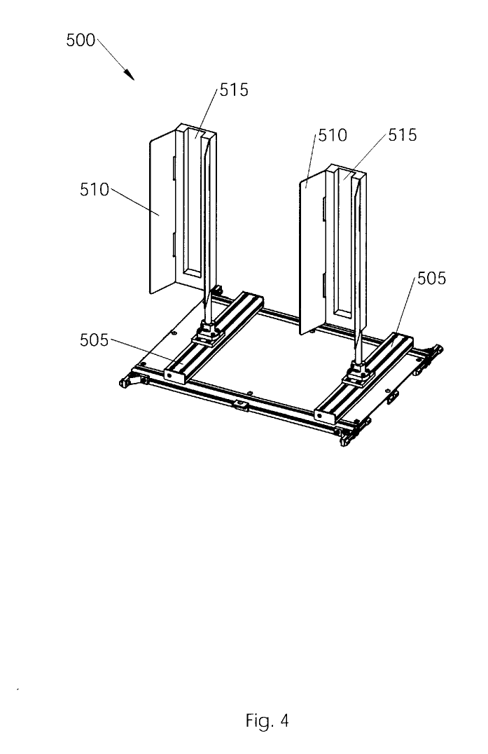

As shown in FIG. 4 and FIG. 6, a lighting subassembly 500 mounted to frame 10 provides proper lighting conditions for capturing images. Ambient light surrounding apparatus 1 is blocked by panels 20, and lighting subassembly 500 provides consistent lighting conditions for capturing images within apparatus 1. Lighting subassembly 500 comprises one or more lighting units 515 secured to frame 10. Each lighting unit 515 may be fixedly secured to frame 10; alternatively, each lighting unit 515 may be attached to a rail 505 that is secured to frame 10, and each lighting unit may be movable along its rail 505.

In one embodiment, each lighting unit 515 comprises a single row of light vertically arranged light emitting diodes (LEDs). Though use of a single row of vertically arranged LEDs per lighting unit 515, it is possible to avoid lighting artifacts within the enclosure of the apparatus 1 and achieve uniform lighting conditions. If multiple rows of LEDs were used, constructive and deconstructive effects would occur, causing bright or dark bands across the area to be imaged. In other embodiments, incandescent bulbs or a mix of LEDs and incandescent lighting may be used. The choice of lighting can be optimized for the camera sensor.

As shown, lighting subassembly 500 comprises two lighting units 515 situated adjacent to side view camera subassembly 200. However, lighting units 515 may be mounted in other locations of apparatus 1. If shadows are present in the area to be imaged, additional lighting units 515 may be mounted adjacent to the overhead view camera subassembly 300.

Lighting subassembly 500 may further comprise one or more baffles 510 attached to each lighting unit 515. Baffles 510, often referred to as “barndoors” by photographers, are configured to partially cover lighting units 515, focusing the light provided by each lighting unit 515 onto a particular part of the area to be imaged.

Lighting subassembly 500 can be controlled by computer 600. For example, computer 600 may control the on/off functionality or light intensity of the lighting units 515.

### Computer 600

As shown in FIG. 1 and FIG. 2, a computer 600 is provided to control all subassemblies of the apparatus 1. Images captured using the apparatus 1 may be stored in the storage components of computer 600, or computer 600 may buffer the images captured using the apparatus 1, and transfer captured images to a remote server. Computer 600 may be contained within the apparatus 1; for example, computer 600 may attach to the frame 10. Alternatively, computer 600 may be located outside the apparatus 1, and connected to subassemblies of the apparatus 1 through wired or wireless connections.

The computer 600 may communicate electronically with a remote server that contains experiment information. For example, the remote server may contain the species, images captured in the past, last measured height and width, growing conditions, and other properties for each plant under study.

Each major subassembly of the apparatus 1 may have a separate controller in communication with the computer 600. A power switch controlled by computer 600 capable of cycling power to motors 225, 240, 315, and 415 and cameras 210, 325, and 425 may be included. If a component of the apparatus 1 experiences a fault, the computer 600—controlled power switch can be cycled to return apparatus 1 to a known state.

In one embodiment, the computer 600 comprises a commercially available personal computer.

### Monitor 700

As shown in FIG. 1, a monitor 700 disposed on the outside of the apparatus 1 is provided to indicate the status of the internal components of the apparatus 1, indicate what activities are being performed inside the apparatus 1, display images as they are captured, and display other information related to the operation of the apparatus 1 or plants associated with the apparatus 1. The monitor 700 may be attached to frame 10 or to a panel 20. In one embodiment, monitor 700 has an integrated touchscreen, allowing a user to provide input to the apparatus 1. In other embodiments, users may provide input to the apparatus 1 using a keyboard, mouse, or other input device.

### Barcode Reader

A unique barcode may be placed on the pot of each plant under study, providing a way to identify each plant under study and retrieve images, measurements, and other data associated with each plant. A barcode reader may be provided to identify plants being placed in the apparatus 1 for imaging. In one embodiment, barcode reader is a handheld reader that a user can use to manually scan each plant as it is placed in the apparatus 1. In an alternative embodiment, the side view camera 210 may capture a unique barcode disposed on the plant, and determine the identity of the plant using image processing techniques.

The barcode could be a 1D or 2D barcode, or QC code, or RFID, or other similar device for uniquely identifying a plant for tracking purposes.

### Alternative Lighting and Imaging Subassemblies

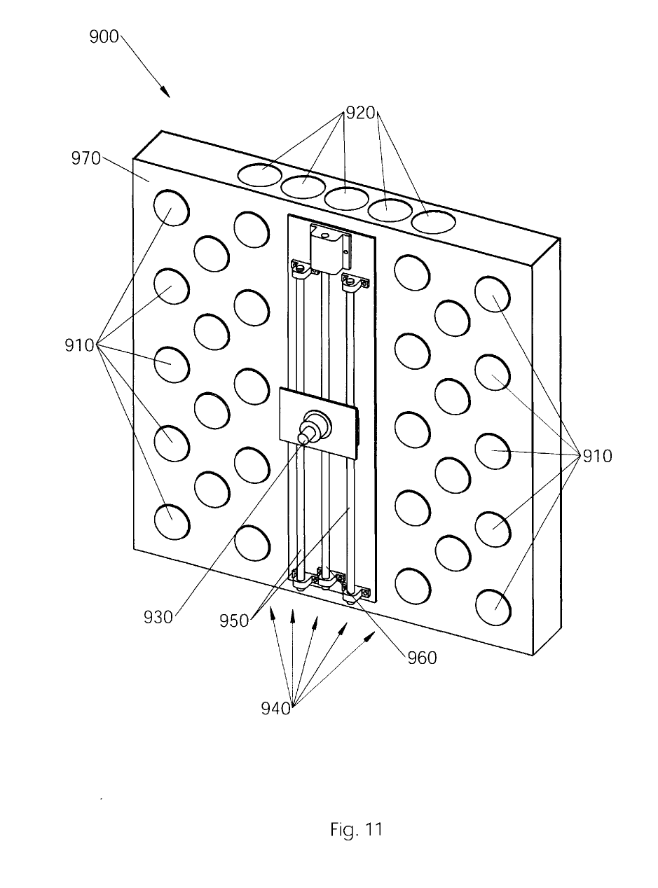

As shown in FIG. 11, in an alternative embodiment of an imaging subassembly 900, a line scanning camera 930, such as a hyperspectral camera, illuminated by incandescent lighting 910 may be used to capture images of the plant. This alternative embodiment targets plants that are significantly taller than wide. The line scanning camera 930 is mounted to a precision moving platform consisting of linear rails 950 and a ballscrew 960 driven by a stepper motor or servo motor. To minimize heating of the linear motion hardware and instrument enclosure and drafts induced by circulating air through the enclosure, all the lights are contained within an enclosure 970, with small clearance between the lights and the closure. Air circulates through enclosure 970, entering through inlets 940. Fans 920 circulate the majority of air within the light enclosure 970, with some air also passing from the instrument enclosure pass and around the lights. If circulation within the instrument enclosure must be minimal, the lighting enclosure 970 could be sealed to the lights 910 eliminating air passing from the instrument enclosure over the lights 910. All air would pass from the outside across the lights and back to the outside.

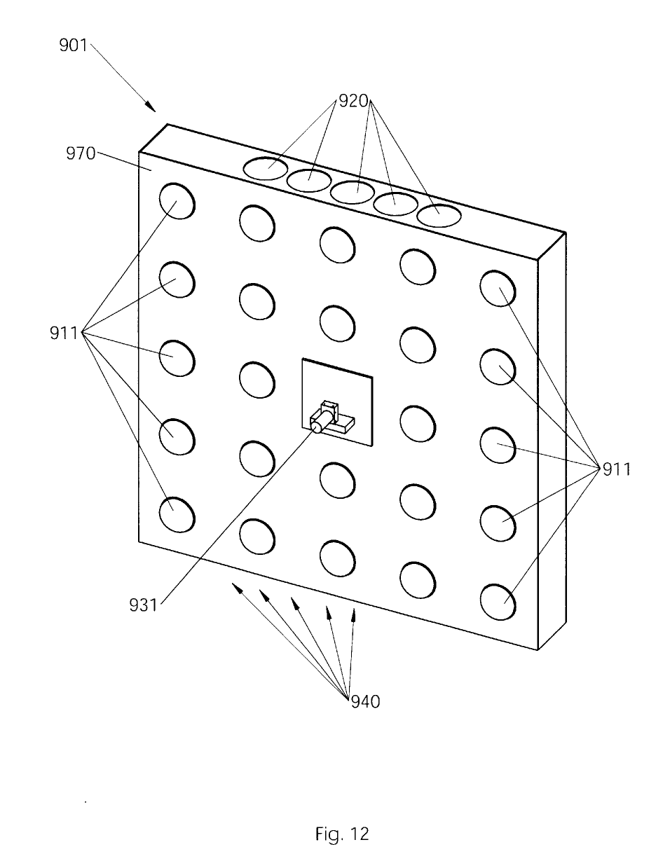

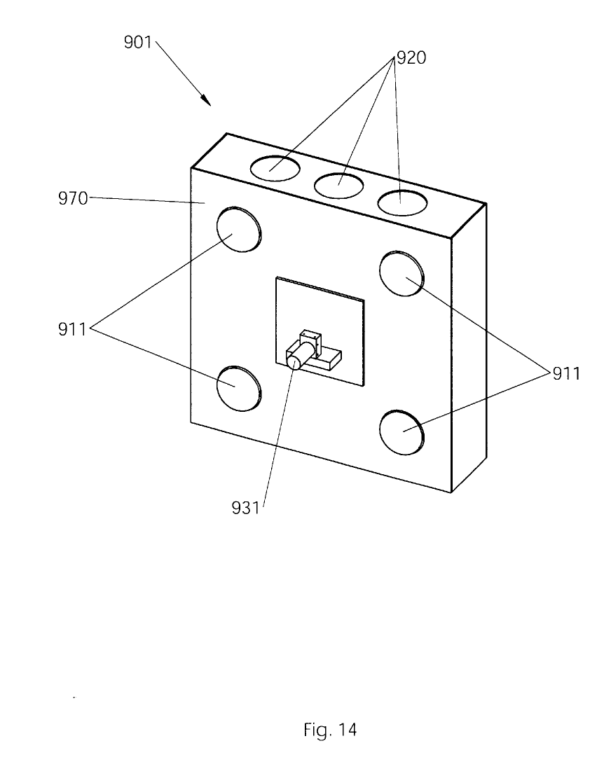

As shown in FIG. 12 and FIG. 14, in an alternative embodiment of an imaging subassembly 901, a stationary frame based camera 931, such as an RGB, near infrared, or thermographic camera, illuminated by incandescent, LED, or fluorescent lighting 911 may be used to capture images of the plant. To minimize heating of the linear motion hardware and instrument enclosure and drafts induced by circulating air through the enclosure, all the lights 911 are contained within an enclosure 970, with small clearance between the lights 911 and the enclosure 970. Air circulates through enclosure 970, entering through inlets 940. Fans 920 circulate the majority of air within the light enclosure 970, with some air lso passing from the instrument enclosure pass and around the lights 911. If air circulation within instrument enclosure must be minimal, the lighting enclosure 970 could be sealed to the lights 911 eliminating air passing from the instrument enclosure over the lights 911. All air would pass from the outside across the lights 911 and back to the outside.

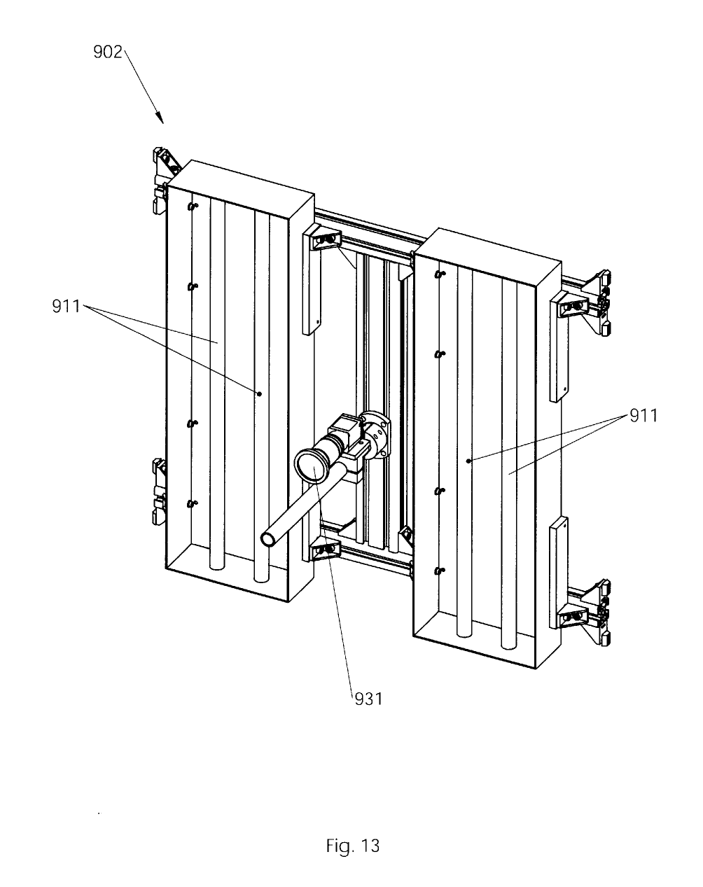

As shown in FIG. 13, in an alternative embodiment of an imaging subassembly 901, a stationary frame based camera 931, such as an RGB, near infrared, or thermographic camera, illuminated by LED, or fluorescent tube lighting 911 may be used to capture images of the plant.

### Methods

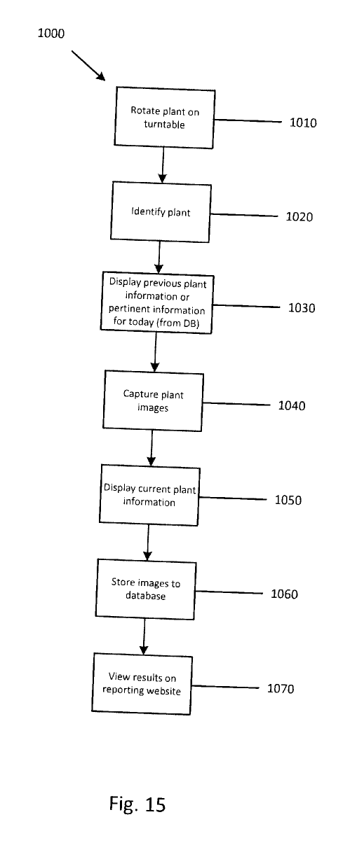

As shown in FIG. 15, a method for capturing an image of a plant 1000 using the apparatus 1 begins at step 1010 with placing a plant on the platform of turntable 100. At step 1020, the plant is identified. If a handheld barcode reader is being used to identify the plant, the user manually scans the barcode on the pot of the plant using the barcode reader, and the unique plant identifier read by the barcode reader is transmitted to the computer 600.

Alternatively, if the identity of the plant is to be identified using the side view camera 210, the access door 30 is closed once the plant is in place inside the apparatus 1, and the computer 600 then transmits instructions to rotate turntable 100 until the barcode on the pot of the plant is visible to the side view camera 210. The unique plant identifier is communicated to the computer 600.

Alternatively, the plan could be identified with a barcode reader permanently attached to the apparatus by rotating the plant until the barcode is found, or with RFID immediately upon entering imaging chamber without any need for rotation.

At step 1030, once the unique plant identifier has been determined, either by handheld barcode reader or side view camera 210, the computer 600 displays information corresponding to the unique plant identifier on the monitor 700. The most recently captured image and analysis for the plant may be displayed on the monitor 700. If the access door 30 is still open at this time, the computer 600 displays a message on the monitor 700 to close the access door 30.

With the access door 30 closed and the plant placed on the turntable 100 and identified, the apparatus 1 can commence imaging the plant at step 1040. Imaging may begin within obtaining a side view image of the plant or an overhead view image of the plant or a corner view of the plant, or obtaining the side view, overhead view, and corner view images, and potentially multiple angled views, may occur simultaneously.

After each image is obtained, the raw image collected and analyzed results are immediately presented to a user of the apparatus 1 at step 1050. If a problem has occurred with apparatus 1 or the plant, the user can immediately fix the problem and obtain a new image. The ability to immediately remedy issues that occur with plant imaging is important since plants continue to grow between imaging sessions, and at the end of an experiment may be destroyed. If missing or flawed images or analysis are not discovered immediately, the opportunity to correct such issues is lost. Processing of images may be performed on the apparatus 1 or sent to a server or cluster of computers at step 1060 for processing with the goal of the perception of immediate feedback to the apparatus 1 operator. At step 1070, the images and other analysis may be viewed on a reporting website.

### Obtaining a Side View Image

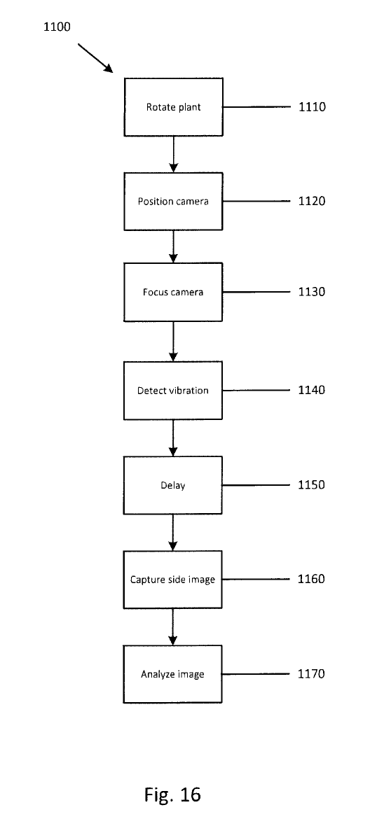

As shown in FIG. 16, a method of obtaining a side view image of a plant 1100 begins at step 1110 in which, prior to obtaining a side view of the plant, turntable 100 may be rotated such that the widest part of the plant is presented to side view camera 210. The optimal side view can be determined in several ways. For example, the turntable 100 may be rotated and with real-time processing of the images, the view with the greatest exposure constitutes the widest side of the plant. In another example, image processing software running on computer 600 can determine which side of the plant is the widest by analyzing an overhead view image of the plant. In another example, image processing software running on computer 600 can determine which side of the plant is the widest by analyzing a combination of overhead, side, and 45 degree view images. Additional data could come from previous images and required rotations from stored data. By using a combination of images, a more accurate result may be obtained than using an overhead view image alone since a wide canopy may hide lower features of the plant from the overhead view camera 325.

In one embodiment, to obtain a side view image using side view camera subassembly 200, the horizontal and vertical position of side view camera 210 are adjusted at step 1120. To position side view camera 210 horizontally, computer 600 instructs a motor controller controlling side view horizontal motor 225 to rotate the shaft of side view horizontal motor 225. Rotation of side view horizontal motor 225 causes rotation of side view horizontal lead screw 220, which causes side view camera platform 215 to move along the lengths of side view horizontal rail 205 and side view horizontal lead screw 220. If the shaft of side view horizontal motor 225 is rotated in a first direction, then side view camera platform 215 and side view camera 210 move toward the plant. If the shaft of side view horizontal motor 225 is rotated in a second direction that is opposite to the first direction, the side view camera platform 215 and side view camera 210 move away from the plant.

To position side view camera 210 vertically, computer 600 instructs a motor controller controlling side view vertical motor 240 to rotate the shaft of side view vertical motor 240. Rotation of side view vertical motor 240 causes rotation of side view vertical lead screw 235, which causes side view camera mount 245 to move along the lengths of side view vertical rail 230 and side view vertical lead screw 235. If the shaft of side view vertical motor 240 is rotated in a first direction, then side view camera mount 245 and side view camera 210 moves toward horizontal rail 205 and horizontal lead screw 220. If the shaft of side view vertical motor 240 is rotated in a second direction that is opposite to the first direction, the side view camera mount 245 and side view camera 210 moves away from the horizontal rail 205 and horizontal lead screw 220.

In an alternative embodiment, a side view image is obtained using angle mounted camera subassembly 400. Through use of angle mounted camera subassembly 400, the optimum horizontal and vertical position of camera 425 is achieved by moving camera 425 along a single axis of motion. To position camera 425 using angle mounted camera subassembly 400, computer 600 instructs a motor controller controlling angle mounted motor 415 to rotate the shaft of angle mounted motor 415. Rotation of angle mounted motor 415 causes rotation of angled lead screw 410, which causes angled camera mount 420 to move along the lengths of angled rail 405 and angled lead screw 410. If the shaft of angle mounted motor 415 is in a first direction, camera mount 420 and camera 425 move along the lengths of rail 405 and lead screw 410 down and toward the plant. Rotation of the shaft of motor 415 in a second direction that is opposite from the first direction causes camera mount 420 and camera 425 to move along the lengths of rail 405 and lead screw 410 upward and away from the plant.

Once the optimum horizontal and vertical position of side view camera 210 is achieved, the side view camera 210 is focused at step 1130. The side view camera 210 may be focused using an auto-focus feature of side view camera 210 or camera 425 may be used to obtain a clear side view image of the plant. Focusing can also be implemented using the movement of the side view camera platform 215 or modification of a standard lens to turn the focus ring or use of a lens such as a liquid lens.

Movement of side view camera 210 or camera 425 can cause vibration that would result in blurry images. If side view camera 210 or camera 425 is equipped with a vibration sensor, such as an accelerometer, to detect vibration, and vibration is detected by the vibration sensor at step 1140, capture of the side view image may be delayed while vibration is present (detected by accelerometer or other vibration sensor) or for a period of time at step 1150 to allow vibration to cease, or the motion measured by the vibration sensor in each axis can be used to correct motion artifacts during image analysis using image processing software. If side view camera 210 or camera 425 is not equipped with a vibration sensor to detect vibration, capture of the side view image may be delayed for a period of time after each movement of side view camera platform 215, side view camera mount 245, or angled camera mount 420 to allow for any vibration to cease before imaging is performed at step 1160.

By adjusting the horizontal and vertical position of side view camera 210 or camera 425 as described above, side view camera 210 or camera 425 is placed at a distance from the plant that ensure that the entire width and height of the plant are captured in resulting side view images, and that maximum coverage of the image sensor of side view camera 210 or camera 425 is achieved. By maximizing sensor coverage, resolution of the measurements that can be obtained from the resulting images is also maximized.

Several methods may be used to ensure that optimal positioning of side view camera 210 or camera 425 has been achieved. In one embodiment, the user may instruct computer 600 via the touchscreen on monitor 700 to move side view camera 210 or camera 425 based on a visual inspection of an image of the plant. In another embodiment, side view camera 210 or camera 425 may be moved away from the plant if image processing software running on computer 600 determines that plant pixels are present along the outermost edges of the resulting image. Likewise, side view camera 210 or camera 425 may be moved toward the plant if image processing software running on computer 600 determines that there are no plant pixels present within a predefined distance from the outermost edge of the resulting image. In another embodiment, prior image stored for the plant may be retrieved by computer 600 and used to obtain the optimal position of side view camera 210 or camera 425. In this embodiment, the age, species, approximate size, and prior positioning information is used to adjust the position of side view camera 210 or camera 425. Further, the position of side view camera 210 can be further adjusted if visual inspection or image processing software indicates that the side view camera 210 is now too close due to increased plant growth that has occurred. The position of the camera 210 is stored and because of previous calibration can be used to convert measurement of pixels into consistent units across any number of images and positions.

After obtaining a side view image of the widest part of the plant, turntable 100 may be rotated to a different position, and the steps above repeated to obtain additional side views of the plant. For example, the plant may be rotated 90 degrees from the widest view and imaged. Alternatively, repeated side view images may be captured as turntable 100 is rotated to obtain a 360 degree view of the plant.

After each side view image is obtained, the raw image collected and analyzed results are immediately presented to a user of the apparatus 1. If a problem has occurred with apparatus 1 or the plant, the user can immediately fix the problem and obtain a new side view image. The ability to immediately remedy issues that occur with plant imaging is important since plants continue to grow between imaging sessions, and at the end of an experiment may be destroyed. If missing or flawed images or analysis are not discovered immediately, the opportunity to correct such issues is lost. Processing of images may be performed on the apparatus 1 or sent to a server of cluster of computers processing with the goal of the perception of immediate feedback to the apparatus 1 operator.

A time series of images and measurements can be more useful to a researcher than a single image or set of measurements. Therefore, the process of obtaining a side view image and associated measurements described above may be repeated multiple times during the life of the plant. As new images and measurements for each plant are captured, previous images and measurements may be presented to the operator using monitor 700, and the operator may use monitor 700 to review current and past images and measurements. By accessing previous images from the server, a researcher can more consistently orient the plant with respect to previous times, and more appropriately compare growth of the plant.

After capturing the side view image, phenotypic measurements, including width, height, leaf count, leaf length, leaf width, leaf angle, tassel length, tassel angle, silk count, flower count, flower size, seed count, organ size, organ color, plant damage, plant health, plant disease, pest damage, pest infestation, chemical damage, presence of non-target plant species, ratio of plant species, or any other characteristic of agronomic, ornamental, or commercial interest. can be obtained from the captured image at step 1170. These traits may be derived from a single image or instrument type, or may be derived from a combination of image or instrument types. Such phenotypic measurements may be determined using software running on computer 600 or a remote server.

### Obtaining a Corner Image

If corner view camera subassembly 450 is present, a corner view image may be captured in a similar manner to the method of obtaining a side view image 1100.

### Obtaining an Overhead Image

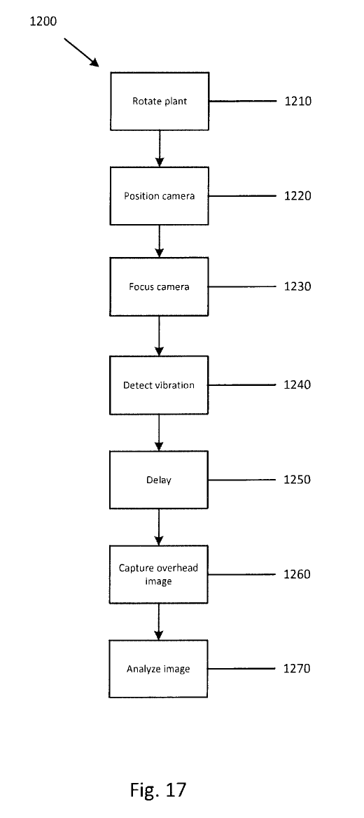

As shown in FIG. 17, a method of obtaining an overhead image 1200 begins at step 1210 in which, prior to obtaining an overhead view of the plant, turntable 100 may be rotated to a desirable position, such as the position in which the widest part of the plant is provided to side view camera 210.

In one embodiment, to obtain an overhead view image using overhead view camera subassembly 300, the vertical position of overhead view camera 325 is adjusted at step 1220. To position overhead view camera 325, computer 600 instructs a motor controller controlling overhead view motor 315 to rotate the shaft of overhead view motor 315. Rotation of overhead view motor 315 causes rotation of overhead view lead screw 310, which causes overhead camera mount 320 to move vertically along the lengths of overhead view rail 305 and overhead view lead screw 310. If the shaft of overhead view motor 315 is rotated in a first direction, then overhead camera mount 320 and overhead camera 325 move toward the plant. If the shaft of overhead view motor 315 is rotated in a second direction that is opposite to the first direction, the overhead view camera mount 320 and overhead view camera 325 move away from the plant.

Once the optimum position of overhead view camera 325 is achieved, the overhead view camera 325 is focused at step 1230. To focus overhead view camera 325, an auto-focus feature of overhead view camera 325 may be used to obtain a clear overhead view image of the plant. Focusing can also be implemented using the movement of the overhead camera mount 320 or modification of a standard lens to turn the focus ring or use of a lens such as a liquid lens.

Movement of overhead view camera 325 can cause vibration that would result in blurry images. If overhead view camera 325 is equipped with a vibration sensor, such as an accelerometer, to detect vibration, and vibration is detected by the vibration sensor at step 1240, capture of the overhead view image may be delayed at step 1250 while vibration is present (detected by accelerometer or other vibration sensor) or for a period of time to allow vibration to cease, or the motion measured by the vibration sensor in each axis can be used to correct motion artifacts during image analysis using image processing software. If overhead view camera 325 is not equipped with a vibration sensor to detect vibration, capture of the overhead view image may be delayed for a period of time after each movement of overhead camera mount 320 to allow for any vibration to cease before imaging is performed.

By adjusting the position of overhead view camera 325 as described above, overhead view camera 325 is placed at a distance from the plant that ensure that the entire plant is captured in resulting overhead view images, and that maximum coverage of the image sensor of overhead view camera 325 is achieved. By maximizing sensor coverage, resolution of the measurements that can be obtained from the resulting images is also maximized.

Several methods may be used to ensure that optimal positioning of overhead view camera 325 has been achieved. In one embodiment, the user may instruct computer 600 via the touchscreen on monitor 700 to move overhead view camera 325 based on a visual inspection of an image of the plant. In another embodiment, overhead view camera 325 may be moved away from the plant if image processing software running on computer 600 determines that plant pixels are present along the outermost edges of the resulting image. Likewise, overhead view camera 325 may be moved toward the plant if image processing software running on computer 600 determines that there are no plant pixels present within a predefined distance from the outermost edge of the resulting image. In another embodiment, prior image stored for the plant may be retrieved by computer 600 and used to obtain the optimal position of overhead view camera 325. In this embodiment, the age, species, approximate size, and prior positioning information is used to adjust the position of overhead view camera 325. Further, the position of overhead view camera 325 can be further adjusted if visual inspection or image processing software indicates that the overhead view camera 325 is now too close due to increased plant growth that has occurred.

After each overhead view image is obtained at step 1260, the raw image collected and analyzed results are immediately presented to a user of the apparatus 1. If a problem has occurred with apparatus 1 or the plant, the user can immediately fix the problem and obtain a new overhead view image. The ability to immediately remedy issues that occur with plant imaging is important since plants continue to grow between imaging sessions, and at the end of an experiment may be destroyed. If missing or flawed images or analysis are not discovered immediately, the opportunity to correct such issues is lost.

A time series of images and measurements can be more useful to a researcher than a single image or set of measurements. Therefore, the process of obtaining an overhead view image and associated measurements described above may be repeated multiple times during the life of the plant. As new images and measurements for each plant are captured, previous images and measurements may be presented to the operator using monitor 700, and the operator may use monitor 700 to review current and past images and measurements. By accessing previous images from the server, a researcher can more consistently orient the plant with respect to previous times, and more appropriately compare growth of the plant.

After capturing the overhead view image, phenotypic measurements, including width, height, leaf count, leaf length, leaf width, leaf angle, tassel length, tassel angle, silk count, flower count, flower size, seed count, organ size, organ color, plant damage, plant health, plant disease, pest damage, pest infestation, chemical damage, presence of non-target plant species, ratio of plant species, or any other characteristic of agronomic, ornamental, or commercial interest can be obtained from the captured image at step 1270. These traits may be derived from a single image or instrument type, or may be derived from a combination of image or instrument types. Such phenotypic measurements may be determined using software running on computer 600 or a remote server.

### Color Analysis

Specialized instruments such as spectrometers including hyperspectral cameras are ideally suitable for measurement of color; however, these instruments and cameras are often prohibitively expensive. Instead, sometimes people attempt to measure color using an RGB camera. The challenge with using an RGB camera is several ranges of overlapping wavelengths are merged into each of the three (or four) color channels. The next challenge is how to perform the comparison after the convolution of color measurements. One could perform a measurement in RGB space, often Euclidean or other distance metrics within the RGB space, which may not relate to intuitive sense of color difference, and many will choose to convert to HSV color space and compare color by comparing the single dimension of Hue. However, both approaches include colors that are not seen in any plant, let alone a particular species of plant. By including colors that will never be measured the discrimination power is reduced. There are only so many color bins available, each channel may have 8-bit, 10-bit, 12-bit, 16-bit, or other discrete number of bins. To maximize the use of those bins for comparison, we develop color spaces that are tailored to a particular plant species and this can include the subtle effects of instrument lighting and optics. By collecting a number of images of the species of interest in various stages of development, stress, and diseases, we can measure the colors that do occur. Through datamining methods including PCA and PLS, we can develop models of color-spaces that improve the discriminatory power of the color analysis system.

Images collected for color analysis are normalized against reference images collected earlier. After the lights have warmed and stabilized, verified with the installed cameras, the reference images are used to normalize the colors in the images. This reduces the effect of changes in lighting and the environment.

### Data Interface

All collected images are stored to a server. The server uses the same methods and additional methods as the instrument to analysis the images and convert the images to data. While the apparatus 1 may only be able to perform a subset of the analyses due to processing time constraints, the server can spend additional time. The goal of performing the analysis on the apparatus 1 is to provide immediate feedback to the operator while the goal of performing the analysis on the server is maximize the data quality even at the expense of time. However, faster processing may be required if the results from the instrument are needed for feeding back into the experiment. The raw image is stored to the server in addition to processed images. Storing the raw image allows future analysis to have full fidelity for reprocessing.

Results (images, data, and statistical summaries) are presented in a web interface accessible on desktop or mobile devices by researchers. Web service interfaces allow other system in an integrated laboratory easy access to the data to inform decisions by this and other instruments and informatics systems.

Operators are able to collect notes at the time of imaging or subsequently associate notes with images and data to better inform researchers at a future date of the state of the plant, apparatus 1, and environment at the time of imaging. Experiment notes need not be restricted to imaging but include any sort of free text data. The notes can be mined for additional structure or trends.

### Integration of Handheld Accessory Instruments

To provide high resolution spectral or color data at a more affordable cost and speed than is possible with a hyperspectral camera, a spectrometer may be used. The challenges with a spectrometer include blocking out the ambient light and being consistent with the placement of the spectrometer probe.

To address the challenge of blocking ambient lighting, a handheld clip device comprising directed controlled source illumination and the spectrometer probe. Fiber cables may be used to separate the light and spectrometer from the handheld clip device. The clip effectively isolates the point of measurement from the ambient light, and bathes the area only in the controlled light. To address the challenge of consistent placement of the spectrometer, one might use a robot but this shifts the challenge to a more complicated motion control problem. Instead, a handheld spectrometer is monitored by the cameras already present in the apparatus 1 enclosure. The current location of the handheld spectrometer is shown superimposed on a blend of an image of the plant as it is at this point and an image of the how the plant was at the last point a tracked handheld spectrometer reading was taken. The combination of previous recording and tracking of current position allows the operator to effectively make decisions of placement that would be difficult for an automated machine. While a person would not remember the exact placement of the handheld spectrometer on each plant, apparatus 1 is particularly well suited to remember the placement by taking an image at the time when the spectrometer reading is taken. The combination of apparatus 1 and human operator results in speed and accuracy.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus for capturing one or more images of one or more plants comprising:
a frame;
an enclosure having a floor;
a turntable attached to the floor of the enclosure
a side view camera assembly attached to the frame and adjacent to the turntable, the side view camera assembly configured to capture one or more images of a plant placed on the turntable;
an overhead view camera assembly attached to the frame above the turntable, the overhead view camera assembly configured to capture one or more images of a plant placed on the turntable;
a computer electronically connected to the turntable, the side view camera assembly, and the overhead view camera assembly; and
a monitor connected to the computer, the monitor configured to display information related to a plant placed on the turntable.

2. The apparatus of claim 1 wherein the side view camera assembly comprises a vibration sensor configured to detect vibration of a movable camera.

3. The apparatus of claim 1 wherein the overhead view camera assembly comprises a vibration sensor configured to detect vibration of a movable camera.

4. The apparatus of claim 1 further comprising a corner view camera assembly attached to the frame, the corner view camera assembly configured to capture one or more images of a plant placed on the turntable, and wherein the computer is electronically connected to the corner view camera assembly.

5. A method for capturing one or more images of one or more plants comprising:
providing a plant to be imaged;
placing the plant on the platform of a plant imaging device;
reading a unique identifier disposed on the plant;
positioning a side view camera having an image sensor installed on the plant imaging device such that image of the plant maximally covers the sensor of the side view camera's image sensor is maximized;
capturing a side view image of the plant;
positioning an overhead view camera having an image sensor installed on the plant imaging device such that image of the plant maximally covers the sensor of the overhead view camera's image sensor is maximized; and
capturing an overhead view image of the plant.

6. The method of claim 5 further comprising displaying the side view image and the overhead view image to a user of the plant imaging device.

7. The method of claim 6 further comprising recapturing the side view image or the overhead view image.

8. The method of claim 5 further comprising analyzing the side view image and the overhead view image of the plant.

9. The method of claim 8 wherein the analysis comprises color analysis.

10. The method of claim 5 further comprising capturing a corner view image of the plant.

11. The method of claim 10 further comprising analyzing the side view image, the overhead view image, and the corner view image.

12. The method of claim 11 wherein the analysis comprises color analysis.

13. The method of claim 10 further comprising displaying the side view image, the overhead view image, and the corner view image to a user of the plant imaging device.

14. The method of claim 13 further comprising recapturing the side view image, the overhead view image, or the corner view image.

15. An apparatus for capturing one or more images of one or more plants comprising:
a frame;
an enclosure having a floor;
a turntable attached to the floor of the enclosure
a camera assembly attached to the frame, the camera assembly configured to capture one or more images of a plant placed on the turntable;
a computer electronically connected to the turntable and the camera assembly; and
a monitor connected to the computer, the monitor configured to display information related to a plant placed on the turntable.

16. The apparatus of claim 15 wherein the camera assembly comprises a vibration sensor configured to detect vibration of a movable camera.
